(19) United States
(12) Patent Application Publication
(10) Pub. No.: US 2007/0274242 A1
(43) Pub. Date: Nov. 29, 2007

(54) MULTI-TAG EMULATOR

(76) Inventors: Kevin Lamacraft, Gloucestershire (GB); David Michael Feuchtwanger, Gloucestershire (GB)

Correspondence Address: LACKENBACH SIEGEL, LLP, LACKENBACH SIEGEL BUILDING, 1 CHASE ROAD, SCARSDALE, NY, 10583, US

(21) Appl. No.: 11/572,810

(22) PCT Filed: Jul. 28, 2005
(86) PCT No.: PCT/GB05/02990

§ 371 Date: Mar. 28, 2007

(30) Foreign Application Priority Data
Jul. 29, 2004 (GB) 0416922.3

(51) Int. Cl. H04B 7/00; H04Q 5/22

(52) U.S. Cl. 370/310; 340/10.2

(57) ABSTRACT

The invention provides both a system, device and method for emulating a plurality of RF data storage devices in a single device, for example a hand held device such as a mobile phone. The system comprises a means for emulating a plurality of RF data storage devices each having a different identifier, control means for controlling the transmission simultaneously or sequentially of two or more of the identifiers in response to receipt of a signal from a reader, and means for transmitting simultaneously or sequentially two or more of the said identifiers. In one embodiment the transmission of the identifiers emulates the sequential transmission of two or more identifiers in accordance with a collision avoidance protocol. Alternatively or additionally the transmission of the identifiers emulates the simultaneous or sequential transmission of two or more different identifiers in accordance with a collision detection protocol. Preferably each of the identifiers comprises a different modulation sequence or pattern and the transmitted identifiers are generated by combining at least part of the modulation sequence or patterns of the data storage devices.

The invention relates to tags for example as used in radio-frequency identification (RFID), and in particular concerns an apparatus and method for emulating a series of co-located RFID tags. The term ‘RFID’ or ‘RFID system’ as used herein should be understood to include both traditional RFID systems, in which an RFID tag supplies data to an RFID reader, systems such as near field communication (NFC) systems and other systems which are for the storage and retrieval of data and/or commands via the use of radio frequency fields or signals. Likewise the term ‘RFID tag’ or ‘tag’ as used herein should be understood, where the context permits, to include transponders and NFC devices in tag-mode or data storage devices in similar form or with similar function; and the term ‘RFID reader’ or ‘reader’ as used herein should be understood, where the context permits, to include transceivers and NFC devices in reader-mode or similar devices or devices with similar function.

The growth and diversity of radio-frequency identification (RFID) applications is progressing rapidly and now includes near field communication (NFC) systems. Existing RFID system concepts, based on isolated and/or single reader and tag functionality, do not necessarily provide the optimum system level solution for an ever-increasing diversity of application areas. Many of these emerging application areas require multiple co-located RFID tag functionalities to exist within an isolated RFID device such as a transport ticket, or within a hand held device such as a mobile phone or personal digital assistant (PDA) or the like. An example of such an application area is the emulation of multiple mass-transport RFID tickets by a hand held device in such a way that the ticket information contained within a hand held device can be read by a mass-transport RFID reader in exactly the same way as an individual or series of individual conventional mass-transport RFID/contactless tickets are read.

RFID applications often conform to a designated standard or protocol, for example ISO/IEC 14443, ISO/IEC 15693, ISO/IEC 18092 and ISO/IEC 21481. These standards or protocols are usually designed so that if two or more RFID tags are simultaneously within range of a reader, a data or communications collision will occur when the tags transmit data simultaneously in response to a signal from the reader. Readers are then capable of following a method to distinguish the different RFID devices using anti-collision methods.

Several technical problems need to be addressed to realise multiple co-located RFID tags in a single device or apparatus.

A solution to this technical problem could involve the implementation of separate RFID functionalities, each with its own antenna, within the same hand held device. In this case each of the separate RFID functionalities would perform according to it's designated standard or protocol and so cater for co-located responses to a reader, just as if the RFID functionalities were physically separate. However, close proximity of the antennas will result in interference between the antennas.

This effect is especially acute for proximity or vicinity coupled systems where the coupling mechanism is magnetic. A possible solution to this problem would involve either positioning the antennas at mutual magnetic nulls, or including an enable/disable function so that each antenna would be disabled when not in use. The former would have the difficulty of the null being moved by external influence, and the latter would never be completely disabled due to parasitics in components. These solutions also result in increased complexity, cost and size.

Another solution to the above mentioned technical problem could involve the user interface of the hand held device (mobile phone/PDA for example) being adapted to allow the user to select a single tag (for example a train ticket) from multiple tags stored within the device when required, and then to use a common RFID circuit and antenna means to transmit the selected tag identification and/or other data relating to the tag or application to a reader. This solution, however, is of little or no practical use when the user is faced with a congested environment or with making a time critical RFID/contactless/wireless transaction.

It is known to implement single RFID tag functionality within a hand held device, for example EP 1424657A1 discloses an electronic RFID ticket implemented within a mobile telecommunications device (a mobile phone is shown), using the existing microprocessor, memory, coder/decoder, display and power supply of the mobile device with additional software and hardware.

Anti-collision protocols are also known, for example as described in U.S. Pat. No. 5,365,551. In this earlier patent the units that transmit colliding signals are all physically separate from each other. This document discloses a protocol for uniquely identifying a plurality of transceivers that simultaneously respond to a commander or base station using a common communication medium. If more than one of the transceivers broadcasts at the same time an erroneous message is received, which causes the commander station to broadcast a command causing each transponder to select a random number which it then uses as its arbitration or identification number. By broadcasting requests for identification to various subsets of the fall range of arbitration numbers and checking for error-free response, a commander station can determine the arbitration number of every transponder. Consequently, a commander station can communicate individually with each transponder once they have been identified.

According to an aspect of the present invention there is provided an RFID system comprising means for emulating a plurality of RF data storage devices each having a different identifier, control means for controlling the transmission simultaneously or sequentially of two or more of the said identifiers in response to receipt of a signal from a reader, and means for transmitting simultaneously or sequentially two or more of the said identifiers.

The present invention solves the technical problem of implementing multiple co-located RFID tags in a single device by emulating conformance to or compliance with collision detection or collision avoidance methods/protocols in such a way that signals from apparently separate RFID devices, as seen by the RFID reader, actually emanate from, or are coupled from, the same antenna on the same device. Tag emulations are carried out within one or more of: a microprocessor, microcontroller, reduced instruction set computer (RISC), state machine or the like, contained within the single device or where the device is part of a host system or larger device within the microprocessor, microcontroller or other control means within the larger device or host system. These emulations provide controlling influence over the functionality within the device which is used to transmit data in response to receipt of an RF signal.

Preferably the transmission of the identifiers emulates the sequential transmission of two or more different identifiers in accordance with a collision avoidance protocol and/or the simultaneous or sequential transmission of two or more different identifiers in accordance with a collision detection protocol.

Preferably each of the identifiers comprises a different modulation sequence or pattern and the transmitted identifiers are generated by combining at least part of the modulation sequence or pattern corresponding to the data storage devices.

Preferably the transmitted identifier is generated by combining at least part of the modulation sequence or patterns of a selected group of sequences or patterns corresponding to a set of data storage devices.

In preferred embodiments the simulated signal modulation sequence or pattern comprises the summation of at least part of the modulation sequences or patterns of the identifiers.

Each data storage device being emulated may comprise an RFID tag or device incorporating RFID tag functionality, preferably the RFID tags or devices comprise RFID tickets.

In preferred embodiments the system comprises a single antenna for transmitting the identifiers.

The present invention also contemplates a device comprising a system as referred to in the above aspect of the invention. For example the device may be a mobile phone, PDA or other hand held device.

According to another aspect of the invention there is provided a method of operating an RFID system. This method comprises the steps of: emulating a plurality of RFID tags, the tags each having a different identifier associated therewith; and simultaneously or sequentially transmitting the identifiers by the device. This method is preferably automated and capable of implementation in an RFID system independently of user input, that is to say the method is implemented without user intervention, for example without the user having to manually select a particular RFID tag.

Preferably the method further comprises a step for receiving the transmitted identifiers and detecting a plurality of RFID tags by identifying the received identifiers as a collision event between two or more tags. The method may further comprise the step of implementing a collision avoidance and/or a collision detection protocol to enable the emulated RFID tags to be read by a reader.

Preferably the said data storage devices comprise contactless tickets.

In general, RFID devices may include any of RFID readers, tags and NFC devices:

An RFID reader may transmit an RF signal which may be modulated by the reader in accordance with data and/or commands stored within the reader. The reader will also receive RF signals (either modulation of its own previously generated signal, a new RF signal or a modulated new RE signal). The reader may derive power from such a received signal. It may demodulate the received RF signal and respond to the received RF signal in accordance with any data and/or instructions contained within such an RF signal and/or data stored within the reader. Example RFID readers are described in various international standards, ISO/IEC 14443, ISO/IEC 15693.

An RFID tag, when in the vicinity or range of a suitable RF signal will receive the RF signal and where necessary demodulate that RF signal. The tag may also derive a power supply or additional power supply from the received RF signal. This is particularly the case where the tag does not have its own power supply. The tag will respond to a received RF signal in accordance with any data and/or instructions contained within such an RF signal and/or data stored within the tag itself. The response may be either modulation of a new RF signal or modulation of the received RF signal (via load modulation) or transmission of a new RF signal. Example RFID tags are described in various international standards, ISO/IEC 14443, ISO/IEC 15693.

An NFC device comprises both RFID reader and RFID tag functionality within the same device or apparatus. The function of the NFC device depends on the mode of operation and the status of the apparatus (referred to as ‘initiator’ and ‘target’ in the standards). When in target mode (or tag mode) the NFC device acts in a similar fashion to the RFID tag described above. When in initiator mode (or reader mode), the NFC device initiates or supplies an RF signal. Examples of NFC devices are described in ISO/IEC 18092 and ISO/IEC 21481.

For the avoidance of doubt the present invention may be implemented in a device or system comprising RFID tag functionality or NFC device functionality, but not necessarily a device or system comprising all the functionality of an RFID or NFC device. The present invention may also be implemented in a dedicated device in standalone form (either hand held or free standing) or comprised within a larger device or host device/system comprising other functionality, for example a mobile communications device, PDA, personal computer, laptop, games console or vending machine etc. Such apparatus, system or devices may comprise a single integrated circuit or alternatively the different functionalities may be provided by or implemented in separate component parts of separate integrated circuits. In embodiments where the RFID or NFC device or functionality is integrated within a larger device functions may be shared between the NFC or RFID device and the larger device, for example the NFC or RFID may not have its own memory and may instead use memory provided within the larger device.

Embodiments of the present invention are contemplated where multiple RFID tags are emulated within a device such as a mobile phone. However, the present invention also contemplates embodiments in dedicated devices, for example, an RFID transport ticket containing functionality capable of emulating more than one ticket, a patient data storage system in which data from multiple patients is stored (each tag corresponds to a patient chart or medication/care profile). It will be understood by persons skilled in the art that many other systems, devices and methods can be advantageously designed incorporating the present invention.

It will be understood that when functioning to emulate one or more RFID tags, apparatus of the present invention will communicate with an RFID reader or an NFC device which may be in standalone form (either hand held or free standing) or comprised or integrated within a larger device or host device/system, for example a mobile or fixed communications device or system, computer, ticket inspection machine, transport access mechanism or gate etc.

Further features and advantages of the invention will become apparent from the following description of preferred embodiments of the invention, given by way of examples only, which are made with reference to the accompanying drawings.

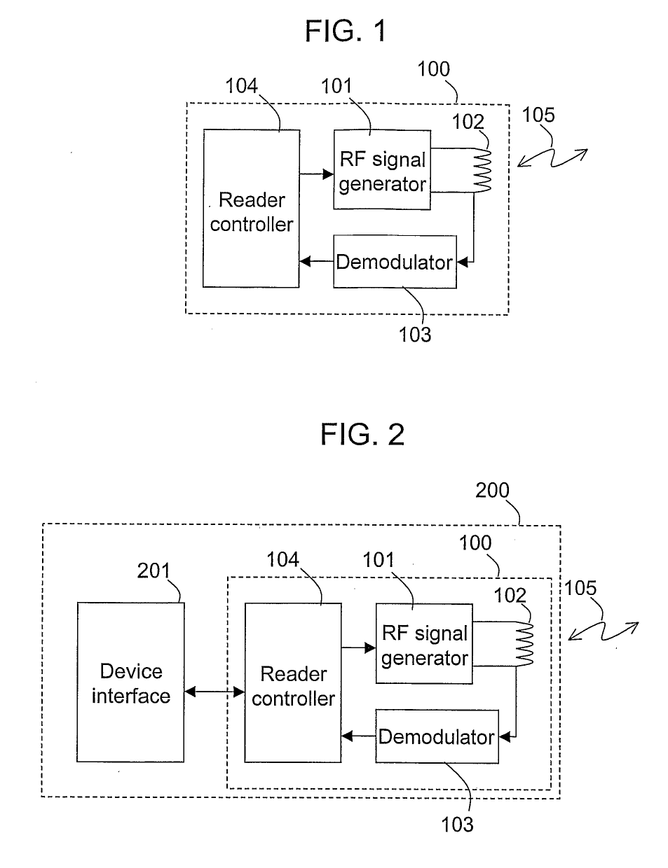

FIG. 1 is a block diagram, of an RFID reader of a known type;

FIG. 2 is a block diagram of the reader of FIG. 1 incorporated within a larger device or system;

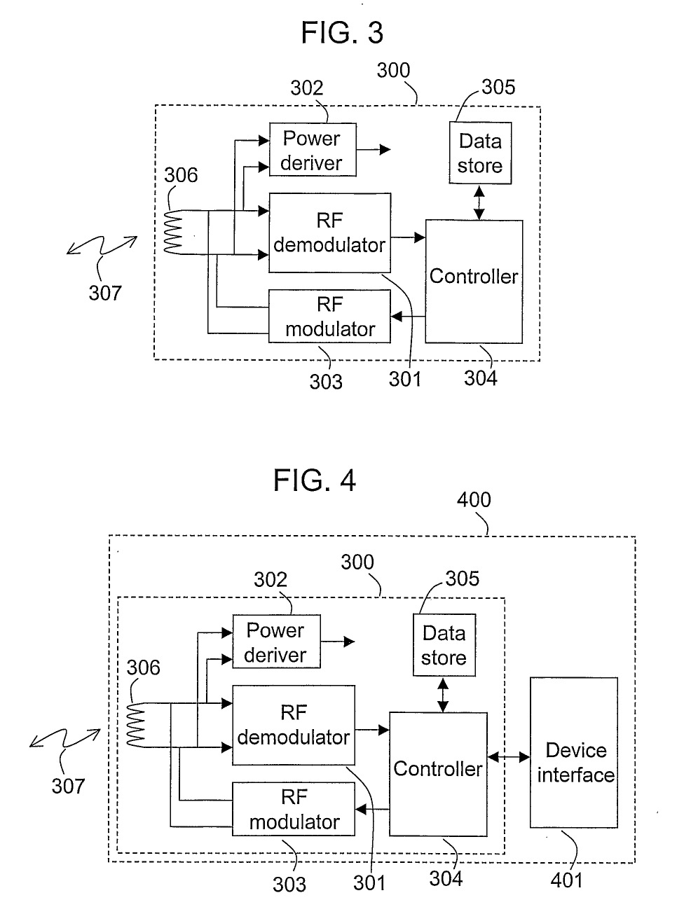

FIG. 3 is a block diagram of an RFID tag of a known type;

FIG. 4 is a block diagram of a larger device or system, incorporating an RFID tag as shown in FIG. 3;

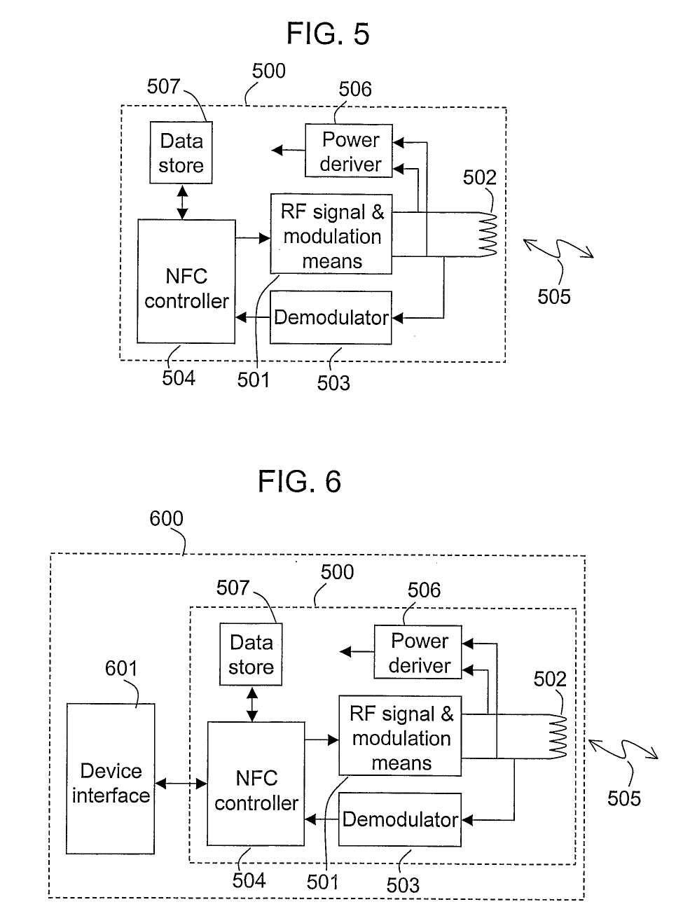

FIG. 5 is a block diagram of an NFC device of a known type;

FIG. 6 is a block diagram of a larger device or system, incorporating an NFC device of the type shown in FIG. 5;

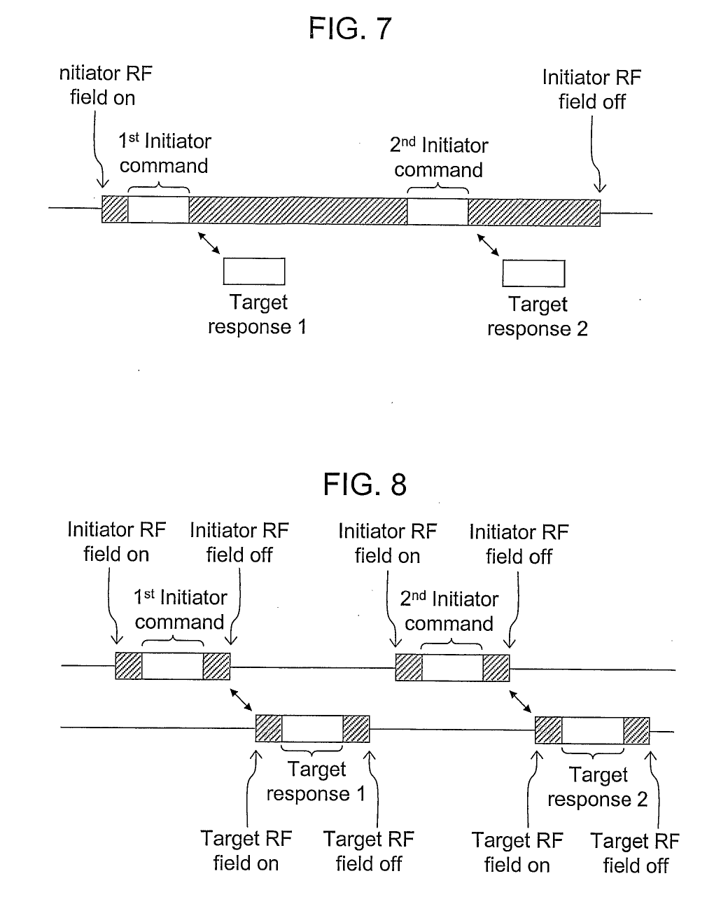

FIG. 7 is a schematic time domain representation of NFC passive communication between NFC devices;

FIG. 8 is a schematic time domain representation of NFC active communication between NFC devices;

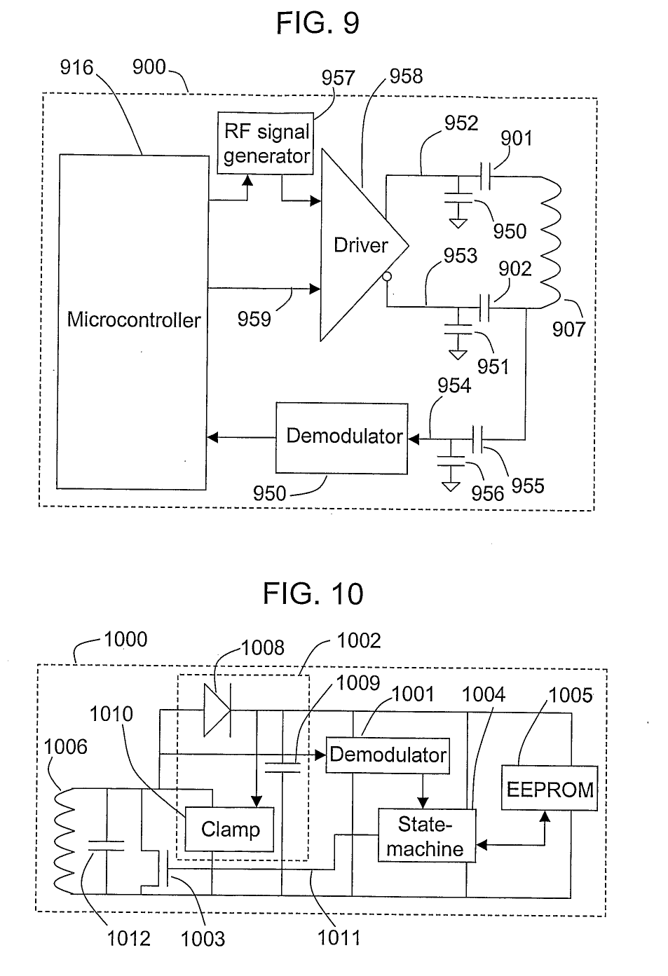

FIG. 9 shows an example of an RFID reader circuit of a known type;

FIG. 10 shows an example of an RFID tag circuit of a known type;

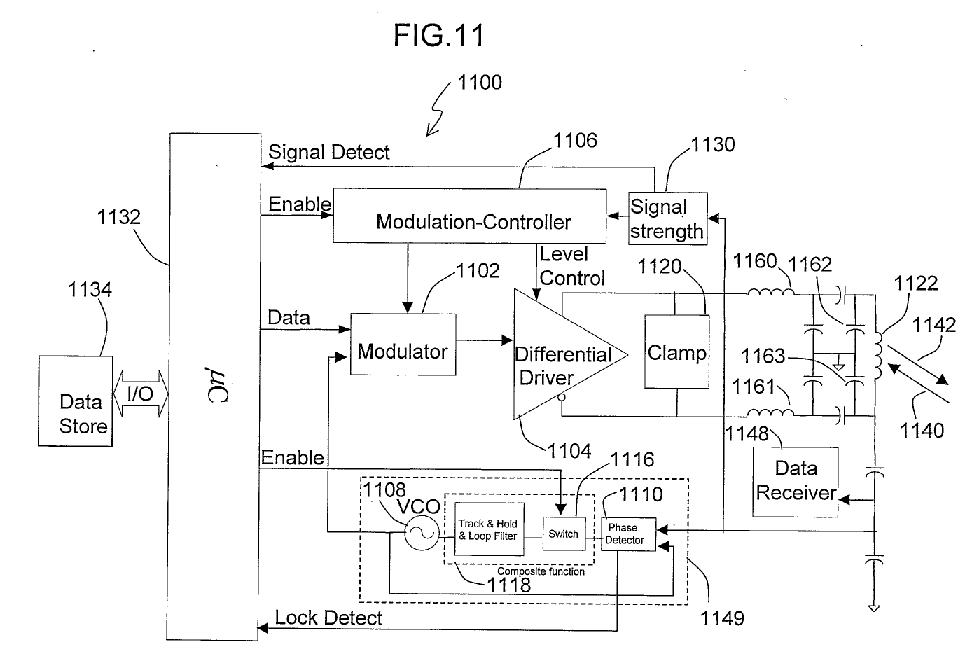

FIG. 11 shows an example of an NFC device circuit of a known type;

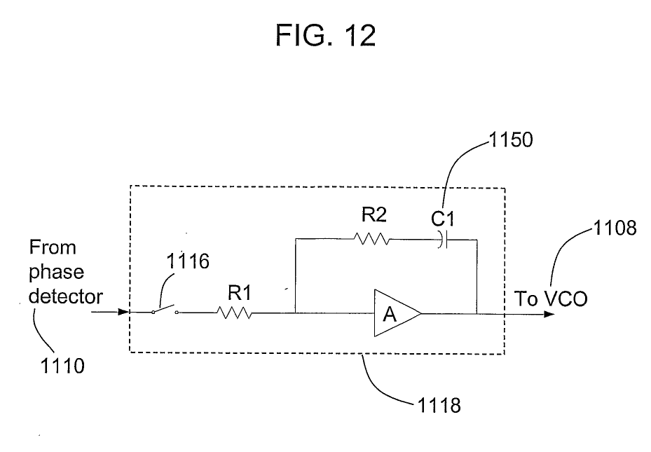

FIG. 12 shows an example of a circuit of part of a phase lock loop of a known type;

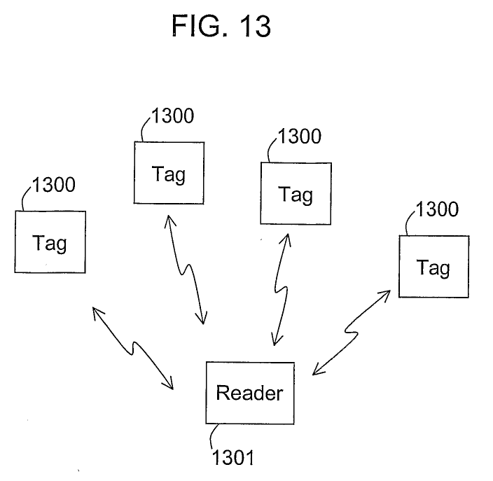

FIG. 13 is a schematic representation of a plurality of RFID tags simultaneously transmitting to an RFID reader;

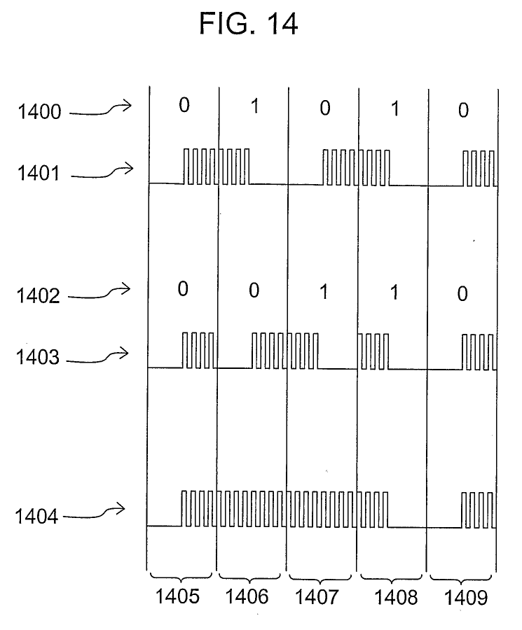

FIG. 14 shows a first example in the vicinity of and of a modulation signalling method of a known type where data collisions occur and are detected;

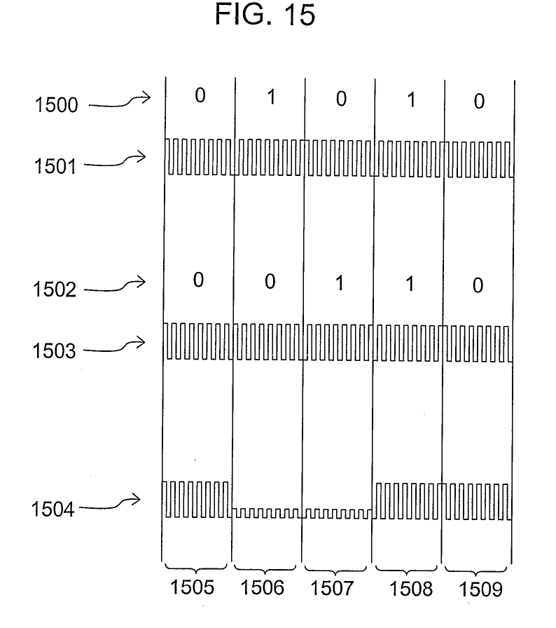

FIG. 15 shows a second example of a modulation signalling method of a known type where data collisions occur and are detected;

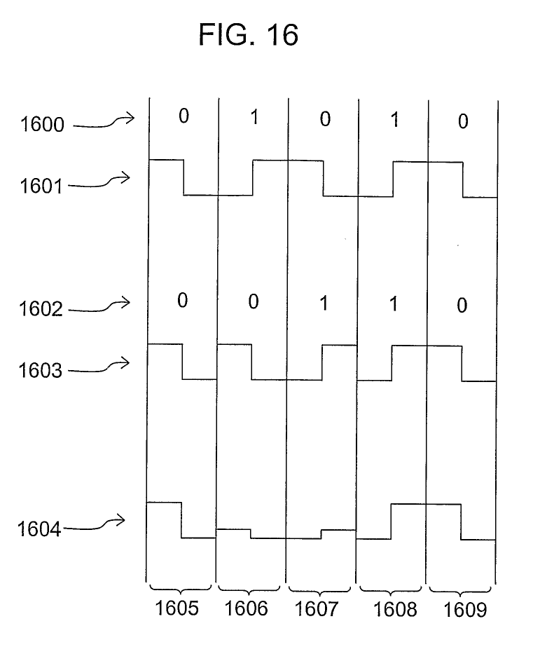

FIG. 16 shows a third example of a modulation signalling method of a known type where data collisions occur and are detected;

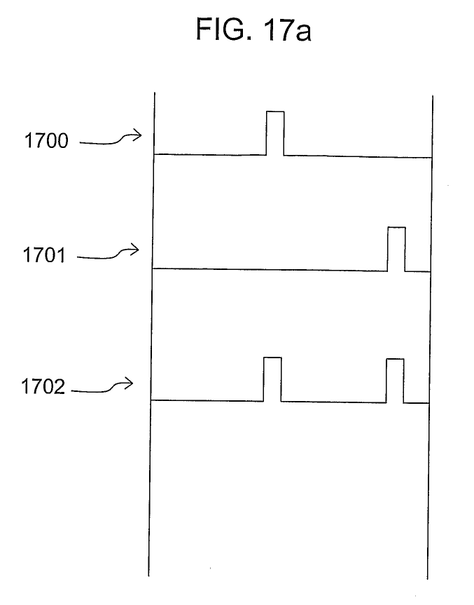

FIG. 17a shows a fourth example of a signalling method of a known type where data collisions occur and are detected;

FIG. 17b shows a fifth example of a signalling method of a known type where data collisions occur and are detected;

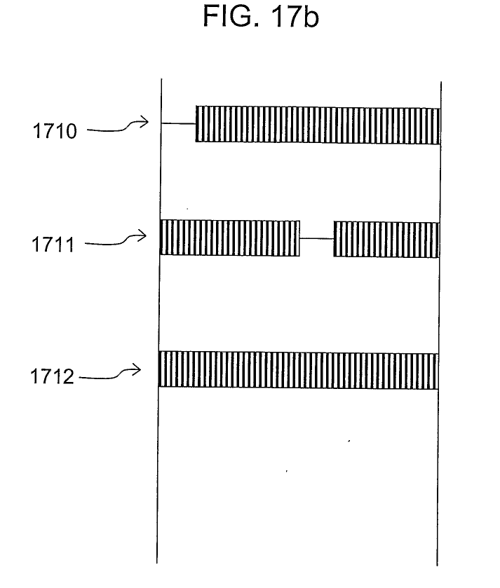

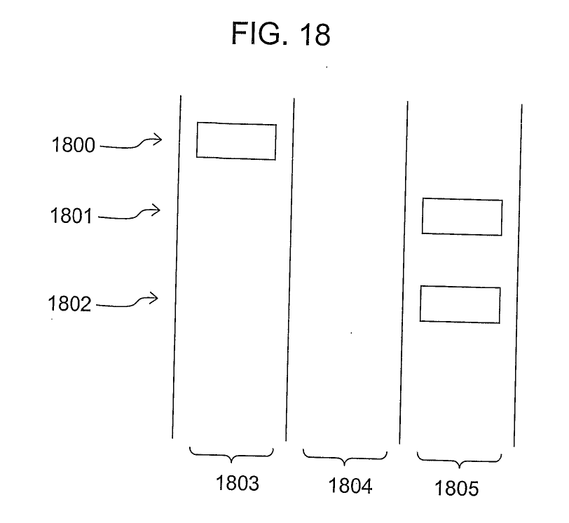

FIG. 18 shows a first example of a collision avoidance method of a known type;

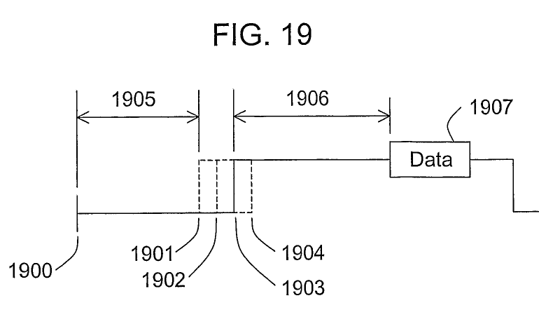

FIG. 19 shows a second example of a collision avoidance method of a known type;

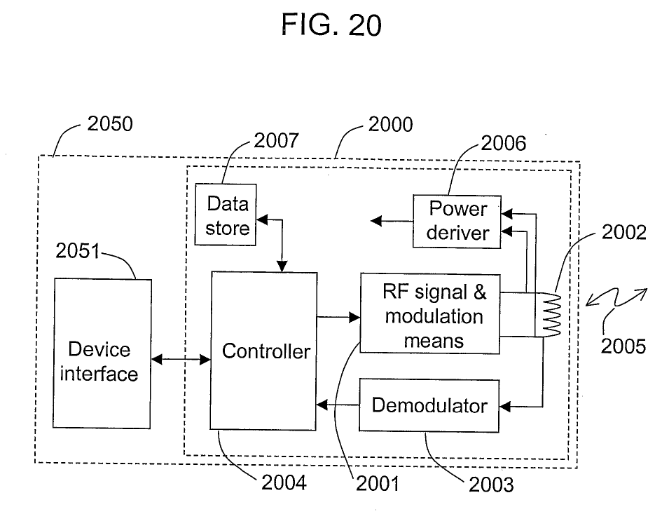

FIG. 20 is a block diagram of elements used in a device according to an embodiment of the present invention;

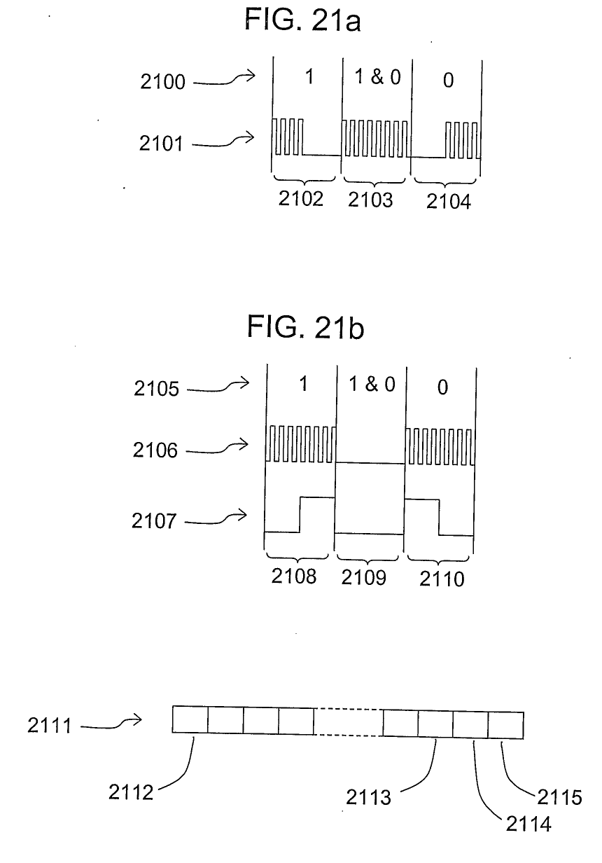

FIG. 21a shows an example modulation signal representing simultaneous transmission of a data bit 1 and a data bit 0 by the device of FIG. 20 when emulating data collisions in protocol that uses the modulation signalling method of FIG. 14;

FIG. 21b shows a second example modulation signal representing simultaneous transmission of a data bit 1 and a data bit 0 by the device of FIG. 20 when emulating data collisions in a protocol that uses the modulation signalling method of FIG. 15 or 16, and also an example where a data collision can be represented by sending incorrect data bits within a multi-byte data packet;

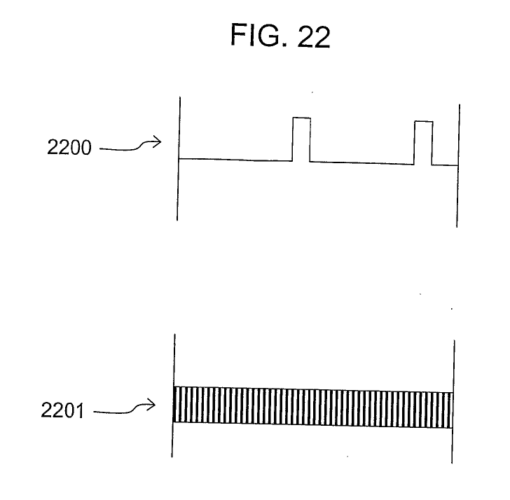

FIG. 22 shows an example modulation signal representing a data collision for a pulse position transmission method, and also shows an example active carrier on one bit period representing data collision;

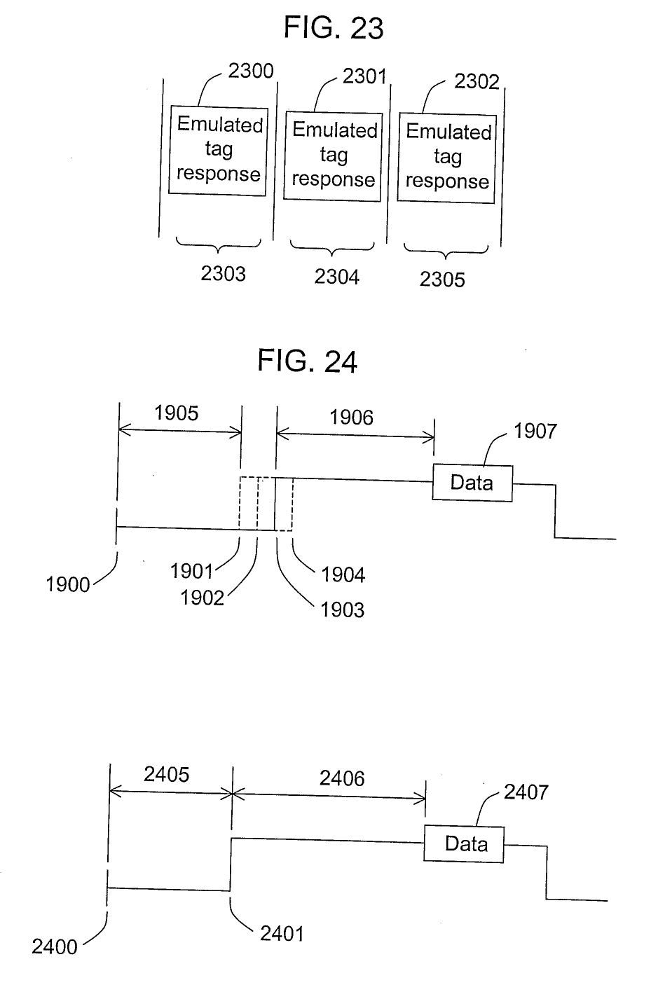

FIG. 23 shows an example where collision avoidance is used by the device of FIG. 20 with a time-slot method of the type illustrated in FIG. 18;

FIG. 24 shows an example where collision avoidance or where data collisions are forced, with a response-time-jitter method;

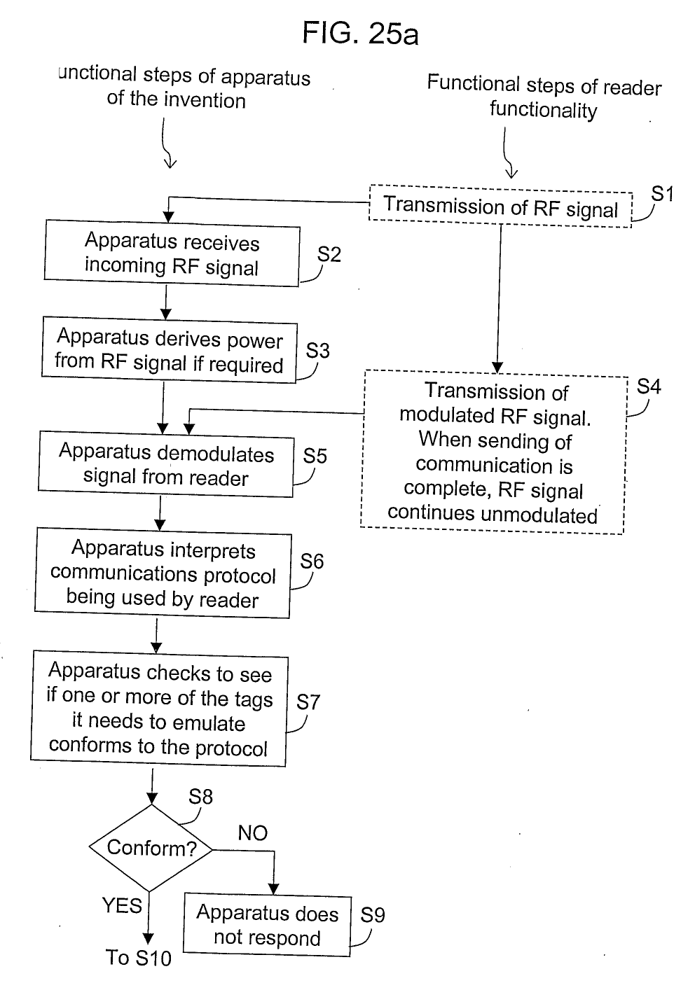

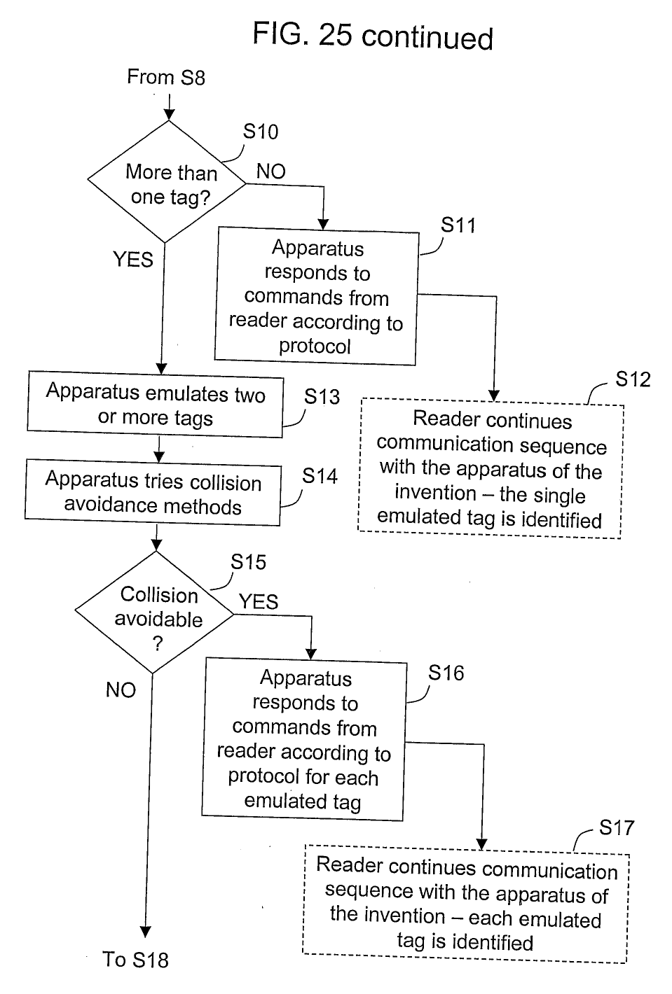

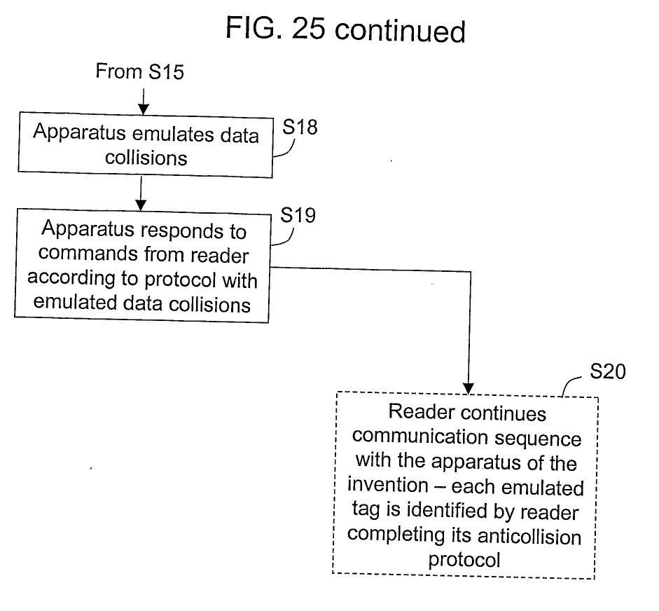

FIG. 25 is a flow diagram of an example embodiment of operation of apparatus of the invention.

Examples of RFID readers, RFID tags, and NFC devices according to various embodiments of the present invention will now be described with reference to the drawings. For the purpose of best describing the example embodiments, reference is first made to the drawings of FIGS. 1 to 19 which show known elements of and illustrate known methods implemented in known types of RFID/NFC devices.

FIG. 1 shows an example RFID reader 100 of a known type comprising an RF signal generating means 101, an antenna 102 connected to the signal generating means and a demodulation means 103. The RF signal generating means 101 generates an RF signal that is fed to antenna 102, which causes a magnetic field represented by the symbol 105 to be generated in the vicinity of the reader 100. A reader control means 104 connected to the signal generation means 101 and demodulation means 103 may or may not cause the RF signal generating means 101 to modulate the generated RF signal. An RFID tag or NFC device in tag-mode within range of the magnetic field 105 will respond to signals from the reader 100, in accordance with the protocol of the reader/tag or NFC device, in such a way that a modulated signal from the tag or NFC device is present at the reader antenna 102 and then demodulated by reader demodulator 103. Data output from reader demodulator 103 is fed to the reader control means 104. The activity or functionality or operation of the reader will be determined by the control means 104 in accordance with the data so obtained. Control means may be, for example, a microprocessor, microcontroller, state machine or RISC processor. It will be understood that the reader control means 104 may further comprise a user interface or the like.

FIG. 2 shows an example of reader 100 from FIG. 1 incorporated within a larger device or system 200. The reader 100 operates in the same manner as described for FIG. 1, but in this case reader control means 104 is further connected to a device interface 201 so that the activity or functionality or operation of the reader 100 or larger device 200 may be determined by the data obtained from the demodulated RF signal by the demodulator 103. Device interface 201 has connections, not shown, to other functionalities within larger device or system 200.

FIG. 3 shows an example RFID tag 300 of a known type comprising a control 304 which is connected to an antenna coil 306 through an RF modulator 303, on a signal transmission side, and an RF demodulator 301 on a signal receiving side. The control 304 may be for example a RISC processor, state machine, microcontroller or microprocessor. The control 304 is further connected to a data storage means 305 comprising a suitable form of volatile and/or non-volatile memory (for example EEPROM). When for example a reader 100 of the type described in FIG. 1 or FIG. 2 causes a magnetic field 307 to be generated in the region of the coil 306 of the tag a voltage is generated across coil 306. Tag 300 may or may not contain a power deriving means 302 for providing power to the elements of the tag, that is to say the tag may be active or passive. In embodiments having a power deriving means (for example passive tags) the voltage across the coil 306 can be used to power all or part of tag 300. If the magnetic field 307 generated by a reader is modulated, then the tag demodulation means 301 demodulates the signal and outputs the demodulated data to the tag control 304. The tag control 304 may be responsive to data from the tag demodulation means 301, power from the power deriving means 302, or from some other internal or external stimulus.

The tag control 304 may also cause data to be read from or written to the data storage means 305. The tag control 304 may similarly respond to data, power or other stimulus and cause data, which might be from the data storage means 305, to be sent to the tag modulation means 303. The tag modulation means 303 when receiving data from the tag control 304 causes, according to that data, a modulated signal to be generated, via the magnetic field 307, at the device originally generating the field, the reader 100 FIG. 1 in this example. The tag control 304 may further comprise a user interface means or the like as previously described in relation to the reader of FIG. 2.

FIG. 4 shows a larger device or system 400, incorporating the tag 300 of FIG. 3. A device interface 401 interacts with tag 300 via the tag control means 304. The device interface 401 has connections, not shown, to other functionalities within the larger device or system 400, and these other functionalities may incorporate some or all of data storage means 305 and tag control 304. Power deriving means 302 may, if present, supply power to some or all of larger device 400.

FIG. 5 shows an example NFC device 500 of a known type. As previously mentioned an NFC device can operate in two modes, as either a reader or a tag, referred to herein as ‘reader-mode’ and ‘tag-mode’ respectively. In this example, when operating in reader-mode, RF signal and modulation means 501, antenna 502, demodulation means 503 and NFC control means 504 operate to provide the same or similar functions as these equivalent elements 101, 102, 103, and 104 as described for FIG. 1, that is to say to provide an RF transmission signal transmitted as magnetic field 505 which has similar characteristics to the field 105 of FIG. 1. In this example, when operating in ‘tag-mode’, antenna 502 and demodulation means 503 provide the same or similar functions as antenna 306 and tag demodulation means 301 in FIG. 3, and in a similar manner, RF signal and modulation means 501 provides the same or similar function as tag modulation means 303 in FIG. 3. In addition, power deriving means 506, NFC control means 504 and data storage means 507, have similar functionalities to the equivalent functionalities 302, 304 and 305 as described in relation to the tag of FIG. 3.

For particular applications, NFC devices can be controlled to operate as either an initiator (reader-mode) or a target (tag-mode). When an NFC device is controlled to be an initiator, the NFC device operates as a reader in a similar manner as the reader of FIG. 1 previously described. When an NFC device is controlled to be a target, the NFC device operates in a similar manner as the tag in FIG. 3, that is to say in a listening mode waiting for a magnetic field to be generated in its vicinity by an RFID reader or another NFC device in initiator mode.

NFC devices function within an active protocol or a passive protocol. Where a passive protocol is used, the device operating as an initiator maintains its RF signal throughout the duration of all communications sequences; and two command-response example sequences are shown in FIG. 7. In the drawing of FIG. 7 the continuous upper block represents the communication period in which the initiator is continuously transmitting an RF signal/field, from ‘Initiator RF field on’ on the left hand side to ‘Initiator RF field off’ on the right hand side. The two unshaded areas (1^{st} Initiator command and 2^{nd} Initiator command) represent the supply of first and second command data from the initiator. The two unshaded shorter blocks below the continuous block represent receipt of response data from the target in response to the first and second initiator command signals (Target response 1 and Target response 2 respectively). Where an active protocol is used, the device operating as an initiator switches-off its RF field when it finishes sending a command, then a responding target switches on its own RF field to send its response information back to the initiator; and examples of two command-response sequences are shown in FIG. 8. The drawing of FIG. 8 is similar to that of FIG. 7 in that the blocks on the upper time line are representative of the initiator transmitting to the target and the blocks on the lower time line are representative of the target responding. The shaded areas represent the time at the start and end of the transmission that does not contain any command or response data, for example where the RF field is un-modulated.

An NFC device may be set up to operate in either reader-mode or tag mode as default. The change in mode of operation may be due to the operation of a larger device, receipt of an externally generated RF signal by the NFC device or as a result of some instruction received from within the NFC device or larger device. Preferably the NFC device will be set to operate in tag-mode as default as this has the advantage of saving power within the device or larger device in which it is incorporated.

FIG. 6 shows a larger device or system 600, incorporating an NFC device 500. A device interface 601 interacts with NFC device 500 via its NFC device control means 504. NFC device 500 operates in the same way as described for NFC device 500 in FIG. 5. Device interface 601 has connections, not shown, to other functionalities within larger device or system 600, and these other functionalities may incorporate some or all of data storage means 507 and NFC device control means 504. Power deriving means 506 may, if present, supply power to some or all of larger device 600.

Reader 100 in FIG. 1, tag 300 in FIG. 3 or NFC device 500 in FIG. 5 may be in a suitable standalone form (either hand held or free standing), for example incorporated in a mass transit ticket.

The larger device or system 200 of FIG. 2, 400 of FIG. 4 or 600 of FIG. 6 may comprise or be part of a host device or system, for example a mobile or fixed communications device, PDA, personal computer, computer, vending machine, electronic wallet, ticket inspection machine, transport access mechanism or gate etc. When forming part of a larger device, an RFID reader, RFID tag or an NFC device may be included as a discrete unit, be integrated within the electronic circuitry of the larger device or alternatively use parts of the electronic circuitry and parts within the larger device.

Known methods to generate and/or modulate RF signals used to provide RFID reader, RFID tag or NFC device functionality consist of three main methods and these are referred to herein as ‘carrier generation’, ‘load modulation’ and ‘carrier interference’. These three methods will now be described in more detail below. Apparatus below refers to readers and/or tags as the context permits.

Apparatus operating in accordance with the carrier generation method generates and emits an independent RF carrier signal, which may or may not be modulated. The carrier generation method would usually, but not exclusively, be used to construct an RFID reader apparatus and its use for an RFID reader is explained here with reference to FIG. 9 which is one example of RFID reader circuitry. Microcontroller 916 is designed to carry out the functionality of reader control means 104 in FIG. 1. The microcontroller 916 controls operation of RF signal generation means 957 and in this example the RF signal generation means 957 generates an RF carrier signal at 13.56 MHz. Microcontroller 916 provides modulation control signals 959 to the differential driver means 958.

The modulation control signals 959 control the amplitude of the RF carrier signal that the differential driver means provides to the antenna circuitry. The differential driver means 958 outputs complimentary pulses using techniques well known to persons skilled in the art. The antenna circuitry comprises a plurality of capacitors 901, 902, 950 and 951 and a coil 907 which form a tuned circuit and function to reduce unwanted carrier harmonics, however the main function of coil 907 is to act as an antenna to emit the modulated RF carrier signal. Microcontroller 916 will typically use modulation control signals 959 sent to the differential driver means 958 to alter the signal level, the modulation depth, relating to binary data desired to be sent according to predetermined patterns relating to a ‘1’ or a ‘0’. Where an un-modulated RF carrier signal is desired, the modulation control signals 959 control the differential driver means 958 to output full amplitude RF carrier signal.

Capacitors 955 and 956 limit the amplitude of the signal input to the demodulator 950 so as to avoid over-volt damage to the demodulator. The demodulator 950 is used to demodulate signals from an external device within reception range, an RFID tag for example, where modulated signals are coupled to the antenna 907. Demodulator 950 outputs demodulated signals in binary form to microcontroller 916.

In this example of the carrier generation method the RF signal generation means 957 is constructed to generate the RF signal by the well-known technique of sine synthesis. RF signal generation means 957 provides a pulse-width modulated (PWM) or a pulse-density modulated (PDM) digital signal to the differential driver means 958. The PWM or PDM signal is generated from a code stored on a Read Only Memory (ROM). The ROM data is fed to a Shift Register (SR), the output of which forms the PWM or PDM serial data stream. The ROM code is generated by a sine synthesis technique well known to persons skilled in the art. It is well understood by those skilled in the art that the sine synthesis PWM or PDM code could be generated by alternative means such as a processor means running a pre-configured algorithm. The PWM or PDM data stream controls differential driver means 958 such that complimentary pulses are output in the most advantageous way to minimize unwanted RF signal frequencies being emitted. System configurations and requirements may facilitate the advantageous removal of capacitors 950 and 951 where the nature of the signals from differential driver means 958 maintains the avoidance of infringing emissions regulations. If the sine synthesis technique were not used, then to conform to emissions regulations, additional filtering circuitry would be required, for example additional inductors and capacitors at signal nodes 952 and 953.

Apparatus operating in accordance with the load modulation method modulates the impedance of the signal reception circuitry; there is no active modulation signal. The load modulation method would usually, but not exclusively, be used to construct RFID tag apparatus and its use for an RFID tag is explained here with reference to FIG. 10 which is one example of RFID tag circuitry. An externally generated magnetic field induces an ac voltage across the signal reception circuitry comprising capacitor 1012 and antenna 1006 formed as a coil inductor. An RFID reader or NFC device in reader-mode generates the externally generated magnetic field for example from an RF signal fed to an antenna. The induced voltage is fed to power deriving means 1002, which in this example consists of diode 1008, energy storage capacitor 1009, and over-voltage protection means 1010. Over-voltage protection means 1010 operates to stop voltages on either positive or negative half-cycles of the induced ac voltage from rising to a level where damage could occur to any part of RFID tag 1000. The output of power deriving means 1002 feeds a dc supply voltage to all circuitry within RFID tag 1000 requiring a supply voltage. The state-machine 1004, which performs the same function as the tag control means 304 in FIG. 3, sends a modulation signal 1011 to transistor 1003. The modulation signal 1011 consists of binary data to be sent according to predetermined patterns relating to a ‘1’ or a ‘0’. The binary data to be sent may for example be determined according to one or more of: a control sequence arranged to operate within state machine 1004, data contained within electrically erasable programmable read only memory (EEPROM) 1005, data received by RFID tag 1000 as modulation to the RF signal and demodulated by tag demodulation means 1001. The modulation signal 1011 is fed to transistor 1003, which has a known on-resistance, and so when the modulation signal switches-on transistor 1003, an impedance is switched across the signal reception circuitry. The impedance change caused by transistor 1003 is coupled to the nearby circuit (not shown in FIG. 10) emitting the RF signal in the RFID reader or NFC device. This coupled impedance change causes a signal variation that is demodulated by a demodulator within the RFID reader or NFC device.

Apparatus operating in accordance with the carrier interference method simulates the load modulation method by using an active signal generated to be at the same frequency as, and at a fixed phase relation to, the incoming carrier signal. The carrier interference method would usually, but not exclusively, be used to construct NFC device apparatus and its use for an NFC device is explained here with reference to FIG. 11 which is one example of NFC device circuitry.

When the NFC device is operating in reader-mode it would be usual to use the carrier generation method as described for FIG. 9 and this is shown in this example as items 1132, 1122 and 1148 being equivalent in function to items 916, 907 and 950 in FIG. 9 respectively and also circuit elements 1102 and 1104 being equivalent to item 958 in FIG. 9. In addition although not illustrated in FIG. 11 an RF signal generation means would be present having the same function as 957 in FIG. 9.

In this example the RF signal fed to the antenna is in digital square-wave form and so when comparing with the reader circuitry of FIG. 9, additional filtering components (inductors 1160 and 1161 and capacitors 1162 and 1163) are required to reduce harmonics of the carrier so that emissions regulations are met.

The circuitry of FIG. 11 that is used in tag-mode to operate the carrier interference method will now be described.

The apparatus 1100 includes a micro-controller 1132, a modulator function 1102, a driver function 1104, an antenna 1122 and a phase-locked loop 1149 comprising in this embodiment a voltage controlled oscillator (VCO) 1108, a phase detector 1110, a loop filter and preferably a sample and hold circuit and in this example the filter and sample and hold functions are combined and shown as 1118. Although shown separately the modulator and driver functions 1102 and 1104 may be comprised within the same component. The apparatus will also have access to, whether within itself (for example as part of the microcontroller) or as part of a separate component or larger device, a data store 1134.

The apparatus operates with a power supply (not represented). Such power supply may be specific to the apparatus itself, it may be dependent on the mode of operation or the apparatus may use a pre-existing power supply within a larger device. For example when in tag-mode, the apparatus may derive power from its own internal power supply, from the power supply in a larger device of which it is a part or from an externally generated RF field or signal.

A reader device (not shown, but would be for example an RFID reader or second NFC device, in reader mode) interacts with the apparatus 1100 by employing available radio-frequency signals used in RFID applications and NFC systems. For example in this embodiment RF signals at 13.56 MHz are used. The apparatus receives an RF signal from such an external reader device when the apparatus is within range of the external reader device.

The VCO 1108 will continuously generate an internal RF signal. The phase-locked loop 1149, which is preferably a second order loop, comprises means by which the internally generated RF signal is brought into phase with the received (externally generated) RF signal. In a preferred embodiment, the VCO 1108 is connected to the phase detector 1110 via a composite loop filter and hold function 1118. The phase detector 1110 detects the difference in frequency and phase between the VCO generated RF signal and the received RF signal. A signal is then sent from the phase detector to the loop filter resulting in an adjustment to the voltage generated by such loop filter. This in turn adjusts the phase and frequency of signal generated by the VCO. This process is continuously repeated to ensure the VCO signal and external RF signal match.

The phase lock loop process will continue until an instruction to modulate and transmit the internally generated RF signal is received from the microprocessor. This might occur once phase locking between the external RF signal and VCO generated signal has been detected by microprocessor 1132. Alternatively, this might occur once apparatus is ready to transmit and modulate, for example at a time interval prescribed by operating protocols such as ISO 14443.

As will be understood by persons skilled in the art combinations of other known techniques could be used to provide the functionality of the phase lock loop 1149.

The apparatus 1100 is then arranged to modulate and transmit the VCO generated RF signal in accordance with the operation of the apparatus in reader-mode and as described above and also with reference to FIG. 9, and the relevant description thereof above should be understood to apply.

The modulated VCO generated signal 1142 on transmission from antenna 1122 is set to cause destructive or constructive interference or a combination of both with the received RF signal 1140. The external reader device (not shown) demodulates this interference-modulated signal in exactly the same way that it would demodulate a coupled load-modulated signal from, for example, an RFID tag.

Different types of modulation or interference or combinations of modulation/interference are possible for the transmission of the VCO generated RF signal, e.g. in-phase only causing constructive interference, out-of phase only causing destructive interference, a combination of in- and out-of phase, partially in- and/or out- of phase or a combination of partially in- and/or out- of phase.

In one alternative embodiment, the apparatus includes a modulation controller 1106. The modulation controller 1106 controls the amplitude of the modulated carrier signal or modulated VCO generated signal in accordance with either the proximity of the external reader device, and/or the characteristic of the received RF signal or and/or the proximity of the data storage device. Where the modulation controller uses detection of external signal strength this can be implemented by providing an amplitude-leveling loop having a signal strength detector block 1130 which captures a sampled measurement of the incoming RF signal strength. The strength information can be used, within the micro-controller 1132 and modulation controller 1106, in conjunction with other calibration or predictive data if required, to set and control the modulation depth, with the modulator 1102 and the driver 1104, to a desired value using for example a modulation controller algorithm.

The clamp 1120 is used to reduce the risk of high voltages destroying chip functionality. In circumstances where high voltages might or do occur, for example when the apparatus is in the field of another RF reader device, current is diverted through the clamp thereby preventing high voltages from affecting the chip functionality.

The composite loop filter and hold function 1118 is detailed further in FIG. 12.

When activated the VCO 1108 continuously generates an internal RF signal. Likewise the phase detector 1110, whilst active, continually detects the phase difference between the internally generated signal and any external RF signal and signals the loop filter to increase voltage.

The composite loop filter and hold function 1118 is placed into hold mode by opening a switch 1116 of FIG. 12. When open, the filter can be approximated as a floating integrator whose capacitive element C1, referenced 1150, will hold its state as per the last signal received from the phase detector, neglecting any further signals sent by the phase detector. This function can be better described as a “filter and hold function”. The filter may be commanded into hold mode only when the phase lock loop has completely stabilized and the output of the phase detector 1110 is no longer changing. Alternatively the command can be linked to the modulation and transmission of the VCO signal, for example as required under various communication protocols or as determine by the microprocessor. One or more of, or combinations of any versions of the “three modulation methods” (described in FIGS. 9-12) can be used to construct an RFID reader of FIG. 1 or 2, an RFID tag of FIG. 3 or 4, or an NFC device of FIG. 5 or 6. Where the “three modulation methods” are the methods to generate and/or modulate RF signals; ‘carrier generation’ of FIG. 9, ‘load modulation’ of FIG. 10 and ‘carrier interference’ of FIGS. 11 and 12. One example of such a variation would be the use of the sine synthesis method described for FIG. 9 being used within the method described for FIG. 11 (the interference modulation method). Persons skilled in the art will know that the methods described in FIGS. 9-12 are examples and that there are many other methods and combinations that can be used to provide functionality of RFID readers, RFID tags and NFC devices.

FIG. 13 shows diagrammatically the situation where an anticollision protocol is necessary. Multiple separate tag-functionalities 1300 are all within range of a reader-functionality 1301. Each separate tag-functionality 1300 may for example include any combination as described herein with respect to FIGS. 1 to 12 and consists of apparatus that includes the functionality of an RFID tag, an NFC device in tag-mode, or an NFC device in active-target mode. The reader-functionality 1301 may for example include any combination as described herein in relation to FIGS. 1 to 12 and consists of apparatus that includes the functionality of an RFID reader or NFC device in reader-mode. As each of the tag-functionalities sends its data to the reader-functionality the relevant anti-collision protocol implemented by the reader and tag functionalities will be followed, such that where tag-functionalities respond at the same time with different data, the protocol allows the reader-functionality to separately identify, and separately communicate with, each tag-functionality. Various known anticollision protocols which could be utilised in embodiments of the present invention will now be described.

Anticollision protocols generally consist of one or both of: collision avoidance and collision detection methods. If collision avoidance is used but fails to avoid a data collision then a collision detection method must subsequently be used. When a data collision is detected, the anticollision protocol will then utilize information correctly received, up until the collision occurred, to individually and selectively address particular tag functionalities. This process allows complete identification of all tag functionalities within range of the reader functionality.

Data collisions usually occur because two or more tag functionalities contain different identification data and/ or are of different tag functionality types. It will be readily understood by persons skilled in the art that in other situations, data representing other information could cause data collisions.

FIG. 14 shows a first example modulation signalling method where data collisions occur and are detected. An example data bit sequence of five bit periods is shown; 1405 to 1409. A first tag functionality, A in this example, outputs data sequence 1400 shown as 01010 and represented by modulation signal 1401. A second tag functionality, B in this example, outputs data sequence 1402 shown as 00110 and represented by modulation signal 1403. Modulation for a data bit 0 occurs in the second half of a bit period, and modulation for a data bit 1 occurs in the first half of a bit period. Where tag functionality A and tag functionality B simultaneously transmit modulation signals 1401 and 1403, the reader functionality will demodulate a signal 1404. The reader functionality will recognise at bit periods 1406 and 1407 that modulation has occurred over the whole of each bit period, and this recognition shows that a data collision has occurred. Such data collisions may occur at any one or more data bits. This example shows data collisions from two tag functionalities, however the same method can be used for three or more tag functionalities.

FIG. 15 shows a second example modulation signalling method where data collisions occur and are detected. An example data bit sequence of five bit periods is shown; 1505 to 1509. Tag functionality A in this example outputs data sequence 1500 shown as 01010 and represented by modulation signal 1501. Tag functionality B in this example outputs data sequence 1502 shown as 00110 and represented by modulation signal 1503. Modulation for a data bit 0 occurs as one phase of a signal, and modulation for a data bit 1 occurs as a signal 180 degrees out of phase with respect to the signal representing a data bit 0. Where tag functionality A and tag functionality B simultaneously send modulation signals 1501 and 1503, the reader functionality will demodulate a signal similar to that shown at 1504. During bit periods 1506 and 1507 data collisions occur and due to the colliding signals being out of phase with each other, they tend to cancel each other out. The degree of this signal cancelling will depend upon factors such as for example the relative modulation methods used within tag functionality A and B and also the relative distance that they are away from the reader functionality. The reader functionality may use one or more methods to recognise such data collisions. One such method might be recognising a change in modulation level. A second such method might be that the low level of signal during a data bit collision causes a random decoding of the bit value to be 0 or 1, then if one or more bits have been decoded incorrectly, this can be recognised when a data checking algorithm is subsequently used, such as a cyclic redundancy check (CRC) algorithm. Persons skilled in the art will recognise that other known methods for recognising data collisions may be more or less advantageous. This example shows data collisions from two tag functionalities, however the same method can be used for three or more tag functionalities.

FIG. 16 shows a third example modulation signalling method where data collisions occur and are detected. Modulation signals use the well-known Manchester coding method shown in this example at 1601 and 1603. A signal for a bit 0 is 180 degrees out of phase with the signal for a bit 1, and so the description for the third modulation signalling method and the collision recognition methods can be taken to be the same as given for the second example in FIG. 15.

FIG. 17a shows a fourth example signalling method where data collisions occur and are detected. This method uses a pulse-position technique where the position of the modulation-pulse in a time period is determined according to the data represented by the pulse. In this example tag functionality A transmits data packet 01010 and the position of its modulation-pulse is shown at 1700. In this example tag functionality B transmits data packet 00110 and the position of its modulation-pulse is shown at 1701. Where tag functionality A and tag functionality B simultaneously send modulation signals 1700 and 1701, the reader functionality will demodulate a signal 1702. The reader functionality will recognise that two modulation pulses have occurred during the data packet period, and this recognition shows that a data collision has occurred. This example shows data collisions from two tag functionalities, however the same method can be used for three or more tag functionalities.

FIG. 17b shows a fifth example signalling method where data collisions occur and are detected. This method uses a gap-position technique where the position of the carrier-gap in a bit period is determined according to whether the data bit is a 1 or a 0, and may in addition depend upon the value of previous bits. In this example tag functionality A transmits a data bit 0 by stopping the sending of a RF carrier signal for a short period at the beginning of the bit period, once the gap-time is complete, the carrier signal is switched back on for the rest of the bit period, and this is shown at 1710. In a similar manner, tag functionality B transmits a data bit 1 by stopping its carrier for a short gap time at the beginning of the second half of the bit period and this is shown at 1711. Where tag functionality A and tag functionality B simultaneously send modulation carrier signals 1710 and 1711, the reader functionality will receive signal 1712. The reader functionality will recognise that a carrier signal has occurred over the whole bit period, and this recognition shows that a data collision has occurred. Such data collisions may occur at any one or more data bits. This example shows data collisions from two tag functionalities, however the same method can be used for three or more tag functionalities.

FIG. 18 shows a first example of a collision avoidance method. A reader functionality determines to use a number of time slots, where in the duration of each time slot a complete reader-tag communication can occur. In the example of FIG. 18, three such time slots are shown. According to the protocol being used, when a reader functionality sends a first command, then each tag functionality within range will determine which time slot to respond in. This time slot determination may be done by, for example, each tag functionality generating a random number or by using part of its unique identification number. There is a high probability that for each time slot only one tag functionality will respond, and in this case collision avoidance will have been successful. Where collision avoidance is successful the reader device knows the identity of all tag functionalities within range and can communicate individually with each one as it chooses, for example to read or write additional data. However, if two or more tag functionalities respond in the same time slot, then the collision will be detected using, for example, one of the methods described with reference to FIGS. 14 to 17. Such a collision is shown as an example in FIG. 18 as tag functionalities 1801 and 1802 both responding in the same time slot 1805.

FIG. 19 shows a second example collision avoidance method. In this method, each tag functionality when responding to a reader functionality, generates its own RF field. In this example, time 1900 indicates when a reader functionality has finished sending a first command. A time delay 1905 later is the first time 1901 that a tag functionality may turn-on its RF field. The protocol is such that each tag functionality checks to ensure that another RF field is not present before it switches on its own field, however if it does detect another field, then it does not respond at all to this particular command. The protocol is also such that each tag functionality randomly selects a time that it would like to respond, shown as 1901 to 1904, and this provides a good chance that several tag functionalities will not attempt to respond at the same time. However if two or more tag functionalities do respond at the same time 1903 in this example, then at a pre-determined time delay 1906 later, as determined by the protocol they will both start to send their information during the period 1907. During the time period 1907 one or more data collisions will occur. Such collisions will be detected using, for example, one of the methods described in FIGS. 14 to 17.

FIG. 20 shows an embodiment of an apparatus according to an aspect of the present invention.

An apparatus according to an aspect of the present invention may be constructed using any one or more, individually or in combination, of the methods or functionalities described in FIGS. 1 to 12, and may utilise one or more of the anticollision protocol functionalities described in FIGS. 14 to 19. However, persons skilled in the art will recognise that methods, protocols, and apparatus described in FIGS. 1 to 19 are described by way of example and that other examples are possible that fulfil the desired functionality.

In FIG. 20, RFID/NFC functionality 2000 may be formed from one or more in any combination of the elements within functionalities 100 in FIGS. 1 and 2, 300 in FIGS. 3 and 4, or 500 in FIGS. 5 and 6. The larger device or system 2050 may or may not form part of the apparatus, but if present may take any form as described as 200 in FIG. 2, 400 in FIG. 4 or 600 in FIG. 6.

The antenna 2002 of the RFID/NFC functionality 2000 is a single antenna for all RFID functionality and is capable of sending and/ or receiving RF signals represented as 2005. The antenna 2002 on its own fulfils the same functionality as one or more of antennas 102 in FIGS. 1 and 2, 306 in FIGS. 3 and 4 or 502 in FIGS. 5 and 6, 907 in FIG. 9, 1006 in FIG. 10, or 1122 in FIG. 11

Power derivation means 2006 of the RFID/NFC functionality 2000 of FIG. 20 may or may not be present, but if present may be formed from any one or more functionality as described as 302 in FIGS. 3 and 4, 506 in FIGS. 5 and 6, 1002 in FIG. 10, 1120 in FIG. 11.

Data storage means 2007 of the RFID/NFC functionality 2000 may or may not be present, but if present may be formed from any one or more functionality as described as 305 in FIGS. 3 and 4, 507 in FIGS. 5 and 6, 1005 in FIG. 10, or 1134 in FIG. 11.

Demodulation means 2003 of the RFID/NFC functionality 2000 may or may not be present, but if present may be formed from any one or more functionality as described as 103 in FIG. 1, 301 in FIG. 3, 503 in FIG. 5, 950 in FIG. 9, 1001 in FIG. 10, or 1148 in FIG. 11.

The device interface 2051 of the larger system/device 2050, if present, interacts with functionality 2000 via control means 2004. The device interface 2051 has connections, not shown, to other functionalities within larger device or system 2050, and these other functionalities may incorporate some or all of data storage means 2007 and control means 2004. A power deriving means 2006 may, if present, supply power to some or all of larger device 2050.

The control means 2004 may be formed from one or more in any combination of, or any part of, elements 104 in FIGS. 1 and 2, 304 in FIGS. 3 and 4 or 504 in FIGS. 5 and 6, 916 in FIG. 9, 1004 in FIG. 10, or 1132 in FIG. 11.

RF signal and modulation means 2001 may be formed from one or more in any combination of, or any part of, elements 101 in FIGS. 1 and 2, 303 in FIGS. 3 and 4 or 501 in FIGS. 5 and 6, 958 in FIG. 9, 1003 in FIG. 10, or 1102, 1104, 1106, 1130 and 1149 in FIG. 11.

Two or more tag functionalities are emulated by control means 2004 and RF signal and modulation means 2001 in such a way that anticollision protocols relating to each tag functionality are conformed to. When such emulations are carried out by apparatus incorporating an aspect of the invention, the reader functionality initiating the communications continues the anticollision protocol in use at the time in a completely normal manner. Embodiments of the present invention thereby automatically facilitate multiple co-located tag functionalities to be read without the need for user intervention.

Embodiments of the present invention when carrying-out the emulation of multiple co-located tag functionalities may advantageously attempt to avoid collisions if the present anticollision protocol allows, or if collision avoidance is not part of the present protocol or if collision avoidance fails, then one or more data collision will be emulated. Emulated collision avoidance methods and data collisions may take a variety of forms according to the anticollision protocol being used at the time, and examples will now be described.

Apparatus of the present invention when emulating two or more tag functionalities that use a time-slot method as part of the relevant anticollision protocol as described in relation to FIG. 18, may advantageously determine that each of the emulated tags respond in a different time-slot. This is shown in FIG. 23 where tag functionalities 2300, 2301 and 2302 being emulated within an apparatus of an embodiment of the invention are shown responding in different time-slots 2303, 2304 and 2305 respectively. This will advantageously allow the initiating reader functionality to identify and communicate with all the emulated tags within the apparatus of the invention in the shortest time.

Apparatus of the present invention when emulating two or more tag functionalities that use a response-time-jitter method as part of the relevant anticollision protocol, as described in relation to FIG. 19, may advantageously determine that each of the emulated tags respond in a different jitter-time. This is shown in FIG. 24 where tag functionalities being emulated within an apparatus configured in accordance within an embodiment of the invention could each respond in different times 1901 to 1904. This will advantageously allow the initiating reader functionality to identify and communicate with all the emulated tags within the apparatus by for example selectively halting each tag as it is identified so as to discover all the other emulated tags responding at different times. Alternatively or as well, an apparatus of an embodiment of the invention may advantageously configure all emulated tags to respond at the same time 2401 for example in FIG. 24, so forcing data collisions after time 2406 during the data transfer at 2407 and so allowing the reader functionality to identify all emulated tag functionalities.

If any collision avoidance methods fail to avoid collisions or the algorithm in use at the time does not use collision avoidance, then embodiments of the invention will emulate data collisions.

Where embodiments of the invention emulate data collisions within a protocol that uses data coding as described for FIG. 14, it will be advantageous for the apparatus to send a modulation signal 2101 in FIG. 21a for each data collision represented in bit-period 2103. Such data collisions occur when an apparatus according to an embodiment of the invention is required to send a signal that represents simultaneously sending both a digital 1 and a digital 0, shown in FIG. 21a as 2100 at bit period 2103.

Where apparatus according to another embodiment of the invention emulates data collisions within a protocol that uses data coding as described for FIG. 15 or FIG. 16, it will be advantageous for the apparatus to send a modulation signal 2106 or 2107 in FIG. 21b for each data collision represented in bit-period 2109. Such data collisions occur when an apparatus according to an embodiment of the invention is required to send a signal that represents simultaneously sending both a digital 1 and a digital 0, shown in FIG. 21b as 2105 at bit period 2109.

It may be advantageous for embodiments of the invention to use an alternative method of signalling collided data for emulated tags using protocols described in FIGS. 15 or 16. In this case for example, instead of emulating simultaneous sending of both digital bit 1 and 0 as shown as signal 2105 in bit period 2109 in FIG. 21b, it may be advantageous to send all signals representing data bits as either a binary 1 or 0 shown as signals 2106 and 2107 at bit periods 2108 and 2110. In such a case, apparatus of the invention may then send the incorrect values for one of more data bits so that the reader functionality discovers the bit error during the time that the reader functionality checks the integrity of the transmitted data, during the cyclic redundancy check (CRC) for example. Such incorrect data bits may advantageously be sent during the actual data transmission of a data packet 2111 for example, in FIG. 21b, and such incorrect data may be sent during the initial data byte 2112, any other of the data bytes up to and including the last one 2113, or during CRC bytes shown in this example as 2114 and 2115.

In embodiments of the invention which emulate data collisions within a protocol that uses data coding as described for FIG. 17a it will be advantageous for the apparatus to send a modulation signal 2200 in FIG. 22 for example that emulates in this example, two tag functionalities responding in the same time period with different data.

In embodiments of the invention which emulate data collisions within a protocol that uses interruption of sending of active carrier signals as described in FIG. 17b, it will be advantageous for the apparatus to send a continuous carrier signal 2201 in FIG. 22 during the bit period where the apparatus is required to send a signal that represents simultaneously sending both a digital 1 and a digital 0.

The collision detection and avoidance methods described in FIGS. 14 to 19 and 21 to 24 are shown as examples only and persons skilled in the art will understand that any one or more collision detection method may be used in conjunction with any one or more collision avoidance method. Persons skilled in the art will readily appreciate that many other collision detection and/or collision avoidance methods may advantageously be used. Persons skilled in the art will therefore recognise that apparatus of the invention might advantageously emulate any such additional collision avoidance or collision detection methods.

FIG. 25 shows a flow diagram of an example embodiment of operation of an apparatus of the invention incorporating multiple tag emulator functionality when such apparatus is within range of a reader functionality. Function steps of an example apparatus of the invention are shown on the left-hand side of FIGS. 25a, 25b, and 25c and each step is outlined with a solid line. Functional steps of a reader functionality, within communications range of the example apparatus of the invention, are shown on the right-hand side of FIG. 25 and each of these steps is outlined with a dotted line.

At step S1 the reader functionality transmits an RF signal. An apparatus configured in accordance with the invention within range of the reader receives the RF signal, shown at S2. If such apparatus contains power-deriving means and the apparatus is configured to make use of such power deriving means, then power for some or all of the apparatus is derived from the incoming RF signal, step S3.

The reader functionality then sends a command communication by modulating its RF signal, and when the initial communications according to the protocol being used, have been sent, then the reader functionality continues to send an RF signal but with no modulation, step S4.

At step S5 the apparatus comprising multiple tag emulator functionality according to an embodiment of the invention demodulates the modulated signal sent from the reader functionality. The apparatus interprets the communication so that it can identify the protocol being used by the reader, step S6. When the current protocol is identified by the apparatus, it checks to see if any of its internally emulated tags can respond to the same protocol, step S7. If none of the emulated tags conform to the current protocol then the apparatus does not respond to the reader, step S9. However if one or more of the emulated tags do conform to the protocol, then the apparatus checks to see if more than one of its emulated tags conform to the same protocol, step S10. If only one emulated tag conforms to the protocol then the apparatus responds to the reader according to the protocol, step S11. The reader demodulates data sent by the apparatus and then continues its communications sequence according to the protocol, so that it identifies the emulated tag within the apparatus, step S12. If at step S10 the apparatus finds that it contains two or more emulations of tags that conform to the protocol, then the apparatus may, if the protocol allows, attempt to avoid data collisions by using the protocol's collision avoidance procedure, step S14. Such collision avoidance methods may for example include one or more of those described in FIGS. 23 and 24.

At step S15 the apparatus determines whether a data collision between its emulated tags can be avoided. If a collision can be avoided, then the apparatus responds to the reader according to the identified protocol such that the reader can continue its communication sequence to identify each of the emulated tags within the apparatus.

If at step S15 the apparatus determines that it cannot avoid a data collision between its emulated tags, then the apparatus emulates data collisions according to the current protocol at step S18. Then at step S19 the apparatus responds to the reader according to the protocol, but wherever the apparatus sends data collisions it does so according to example methods described in FIGS. 21a, 21b and 22. The reader demodulates data sent by the apparatus and then continues its communications sequence according to the protocol, such that it identifies when data collisions have occurred so that it identifies all emulated tags within the apparatus, step S20.

At steps S11, S16 and S19 when the apparatus responds to communications from the reader functionality, the apparatus will use one or more or any part of modulation techniques as described in FIGS. 9 to 12.

At steps S4, S12 and S20 the reader functionality continues the communication sequence with the apparatus by modulating its RF signal, then ceasing its modulation, then demodulating modulated signals sent by the apparatus. However, if one or more other separate tag functionalities (not shown) also respond, then the reader functionality will follow its anticollision protocol so that it can identify and communicate with all tag functionalities, including the apparatus of the invention.

At the end of step S4 where the reader functionality completes its transmission of modulated signal, if the protocol requires, the reader will switch off its RF signal. Then at step S11, S16 or S19 the apparatus will generate its own RF carrier signal that it then modulates according to the protocol being used at the time, using for example methods as described for FIG. 9.

An example application and use of such application will now be described. The example application is where multiple tag emulator functionality is incorporated within a mobile phone and emulated tags include public transport tickets. An example journey will be described. A person who owns such a mobile phone starts a journey that requires a bus and then a train journey.

This person starts the journey by purchasing a bus ticket by placing the mobile phone in proximity to the ticket-issuing machine. This person selects a multi-journey ticket-type and the ticket is then wirelessly copied into the phone and payment is taken. Upon boarding the bus, this person holds the phone in proximity to the ticket reader, and then the reader wirelessly reads the ticket and one journey is deducted from the journey quantity-list held within the ticket within the phone.

When arriving at the railway station this person purchases a train ticket in the same manner as for the bus ticket. The phone stores this second ticket data in a separate portion of internal memory that the bus ticket was stored within. The phone now holds two co-located tags. Next, the person walks up to the access gate on the platform and holds the phone in proximity to the RFID ticket reader. The reader interrogates the phone and discovers that there are two tickets within it. The tickets are both of a type conforming to the ISO/IEC 14443A standard, which means that when the phone emulates the two tickets, a data collision occurs during the reading of the unique identification number within each of the tickets. The ticket reader follows the anticollision protocol and identifies both tickets and reads some information from each one. When the reader discovers that one of the tickets is a bus ticket, it ceases communication with the bus ticket and resumes communication with the train ticket. Upon discovering that the train ticket is valid, the reader sends a signal to the gate to open, which allows our person to walk onto the platform and catch the train.

In another example application nurses in a hospital may carry around a portable NFC device which is used both to read patient charts and download data from such patient charts (i.e. download a tag) and to administer and/or provide data for the care of the patient. The NFC device will contain tags relevant to each patient and therefore hold a plurality of co-located tags. A separate reader in the vicinity of the patient may be responsible for controlling drug dosage to the patient. The reader will read data from a corresponding tag to ensure that the correct dosage is administered to the patient. The nurse may bring the NFC device into the proximity of the reader to update the reader information and enable the reader to download the correct information for a particular patient. The reader will interrogate the NFC device and discover that there are multiple tag functionalities residing within it. The NFC device will have emulated a data collision event in accordance with the relevant protocol thus communicating the presence of multiple tags to the interrogating reader. The reader will then use its internal protocol to select the tag it is interested in and continue communication with that tag.

As a further example the multiple tags stored on an RFID device may be unrelated but all comply with the same protocol, for example ISO 14443A. For example one tag may comprise a train ticket, another tag may comprise a music download and a third tag may comprise a security card for admission to a library. In such a case the RFID device would then comprise three co-located tags. Depending on the reader into the vicinity of which the RFID appears, the RFID device will emulate a collision in accordance with ISO 14443A for all three tags it holds. The reader will use its own internal anti-collision protocols to select the tag it is interested in, stop communication with the other tags and continue or resume communication with the tag of relevance.

The above embodiments are to be understood as illustrative examples of the invention. Further embodiments of the invention are envisaged. For example, the proposed solution may also be used with other forms of antenna and other coupling mechanisms, such as far field electromagnetic, acoustic or optical. Other examples of phase coherent detection or phase sensitive detection systems would include but are not limited to injection locking receiving circuitry, parametric amplifying receiving circuitry and delay lock loop receiving circuitry.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1-20. (canceled)

21. An RFID system, said system comprising:
means for emulating a plurality of RF data storage devices each having a different identifier, control means for controlling the transmission simultaneously or sequentially of two or more of the said identifiers in response to receipt of a signal from a reader, and means for transmitting simultaneously or sequentially two or more of the said identifiers.

22. A system as claimed in claim 21 wherein the transmission of the identifiers emulates the sequential transmission of two or more different identifiers in accordance with a collision avoidance protocol.

23. A system as claimed in claim 21, wherein the transmission of the identifiers emulates the simultaneous or sequential transmission of two or more different identifiers in accordance with a collision detection protocol.

24. A system as claimed in of claim 21 wherein each of the said identifiers comprises a different modulation sequence or pattern and the transmitted identifiers are generated by combining at least part of the said modulation sequence or patterns of the said data storage devices.

25. A system as claimed in claim 24 wherein the said transmitted identifier is generated by combining at least part of the said modulation sequence or patterns of a selected group of sequences or patterns corresponding to a set of data storage devices.

26. A system as claimed in claim 21 wherein the transmitted identifiers are generated by the summation of at least part of the modulation sequences or patterns of the identifiers of the data storage devices.

27. A system as claimed in claim 21 wherein each data storage device being emulated comprises an RFID tag or a device incorporating RFID tag functionality.

28. A system as claimed in claim 27 wherein the said RFID tags or RFID devices comprise RFID tickets.

29. A system as claimed in claim 21 wherein the means for transmitting the identifiers comprises a single antenna.

30. A system as claimed in claim 21 wherein the means for emulating a plurality of data storage devices is located or stored within non-volatile memory means.

31. A system as claimed in claim 21 further comprising an RFID reader.

32. A system as claimed in claim 31 wherein the said reader comprises a hand held device.

33. A system as claimed in claim 21 further comprising means for identifying a communication protocol of an RFID device positioned within communications range of the said system, and means for determining whether any of said emulated RF data storage devices are capable of responding to said protocol.

34. A system as claimed in claim 21 implemented in a mobile phone, personal digital assistant, or other hand held device.

35. A mobile phone, personal digital assistant, or other hand held device comprising a system according to claim 21.

36. A method of operating an RFID system comprising the steps of: emulating a plurality of RFID tags in a device, the tags each having a different identifier associated therewith; and simultaneously or sequentially transmitting two or more of said identifiers by the device.

37. A method as claimed in claim 36 wherein the said transmission emulates the sequential transmission of two or more different identifiers in accordance with a collision avoidance protocol.

38. A method as claimed in claim 36 wherein the said transmission emulates the simultaneous or sequential transmission of two or more different identifiers in accordance with a collision detection protocol.

39. A method as claimed in claim 36 further comprising the steps of receiving the said transmitted identifiers and detecting a plurality of RFID tags within the range of the reader.

40. A method as claimed in claim 37 further comprising the step of implementing a collision avoidance and/or a collision detection protocol to enable the emulated RFID tags to be read by the reader.

41. A method as claimed in claim 36 wherein the said method is automated and capable of implementation in a system according to any one of claims 1 to 13 independently of user input.

42. A method as claimed in claim 36 further comprising the steps of: identifying a communication protocol of an RFID device positioned within communications range of the said RFID system and determining whether any of said RFID tags or RFID data storage devices are capable of responding to said protocol.

43. A method as claimed in claim 42 wherein said step of simultaneously or sequentially transmitting two or more of said identifiers is implemented only if more than one RFID tag or data storage device is capable of responding to said protocol.
